(19) United States
(12) Patent Application Publication
(10) Pub. No.: US 2006/0198473 A1
(43) Pub. Date: Sep. 7, 2006

(54) Apparatus and method for detecting preambles according to IEEE 802.11B wireless LAN standard

(76) Inventor: Alain Chiodini, Cagnes sur Mer (FR)

Correspondence Address: BAKER & DANIELS LLP;111 E. WAYNE STREET, SUITE 800, FORT WAYNE, IN, 46802, US

(21) Appl. No.: 11/347,899

(22) Filed: Feb. 6, 2006

(30) Foreign Application Priority Data
Feb. 12, 2005 (DE) 102005006442.6

(51) Int. Cl. H04L 27/06

(52) U.S. Cl. 375/343

(57) ABSTRACT

The present invention relates to the field of wireless communication systems and in particular to an apparatus and a method for short preamble detection within the framework of the 802.11b standard. The present invention can be easily implemented in either the radio part (preferred embodiment) or the baseband part (general case) of a wireless LAN receiver to provide short preamble detection. The inventive method and apparatus utilize a couple of low-complexity cross-correlators respectively fed by an oversampled I and Q signal to detect the presence of a short preamble. A decision on the presence of the short preamble is made by comparing a figure of merit formed by adding the magnitude of the largest peaks respectively yielded by both cross-correlators to a preset threshold. The proposed innovation offers a significant advantage over conventional approaches in terms of gate count and power consumption.

### TECHNICAL FIELD OF THE INVENTION

The invention relates to the field of wireless communication systems and in particular to an apparatus and a method for detecting preambles according to IEEE 802.11b wireless LAN standard.

### BACKGROUND OF THE INVENTION

An 802.11 wireless LAN receiver must detect and recognize incoming signals when listening to the medium. As 802.11 wireless LAN (WLAN) capabilities become a mainstay technology in a host of consumer electronics products, designers must deal with varying power consumption requirements. Since WLAN devices are most of the time in “idle” mode, the power consumed by a WLAN device as it is just “listening” for WLAN traffic is becoming a critical parameter. Thus, designers must pay special attention to preamble detection techniques when building 802.11-enabled architectures.

In 802.11b-compliant WLAN devices a direct sequence spread spectrum (DSSS) mode is used. The DSSS preamble is a series of Barker-11 sequences transmitted with a chip rate of 11 MHz. Each sequence is modulated by the output of a pseudorandom sequence (i.e. transmitted as defined or inverted depending on the output). This is a time domain oriented description. The preamble has a fundamental period of 1 μs. The WLAN device transmits the preamble that is associated with the data mode that is to follow. The traditional 802.11b data modes (1, 2, 5.5, and 11 Mbit/s) are all preceded by the DSSS preamble. In order to achieve the highest throughput available, the device that receives the transmission must detect these preambles within 15 μs of the time that they start to arrive. Indication of the preamble detection must be communicated to the medium access control (MAC) to ensure that any planned transmission is delayed until the medium is free. The state of the medium is signaled by a clear channel assessment (CCA) indicator. In this way, the 802.11 protocol minimizes collisions on the air.

The most obvious use of the preamble is to indicate that a WLAN packet is being sent. In fact, the detection of the preamble is a prerequisite to receiving the packet. If a packet is missed, then the performance of the network will suffer. This should steer the algorithm designer to declare a packet detection whenever there is a chance that the preamble is present. However, falsely declaring a packet detection will also cause the network performance to suffer since this will unnecessarily delay any pending transmissions. Still another consequence of falsely declaring packet detection is the likelihood that it will invoke extra signal processing which consumes more power. It will also create the risk of missing a genuine packet during this processing. Since 802.11 WLAN devices operate in the same frequency band as other technologies such as microwave ovens, Bluetooth, or cordless telephones, there are a lot of other signals to avoid. Interfering signals can cause detection algorithms to falsely declare the detection of a WLAN preamble.

The simplest approach to detecting any signal, while expending the minimum amount of signal processing, is to listen for an increase in the ambient energy of the environment. An energy detector can be implemented in the analog or digital domain. Here a threshold is set and the digital processing is triggered when energy is seen above this threshold. If there are a lot of other signals present or if a high sensitivity is desired then the power hungry digital signal processing is invoked too often. To help avoid this, some property of the signal needs to be exploited. A DSSS preamble can be detected robustly by using a simple matched filter architecture. The problem with this architecture is its low speed of reaction. While this was the method of choice for designers of 802.11 and 802.11b WLAN devices, the new requirement for detecting the preamble in 4 μs, or just four DSSS preamble periods, has made this implementation difficult to justify.

A better method is to use the periodic nature of the preambles. To exploit the periodicity of the preambles, an autocorrelation structure can be used. Since the DSSS preamble has a well-defined period, it is possible to design a structure that looks for both periods. Comparing received samples in the time domain with those received 1 μs before will result in a match when a preamble is received. To allow greater confidence in the detection, several preamble periods can be monitored. The preamble detection is normally carried out within the baseband part of a WLAN receiver by cross correlating a high resolution quantized signal with a pre-stored ideal sequence and comparing a decision variable against a given threshold.

### DISCLOSURE OF THE INVENTION

It is object of the invention to provide an apparatus and a method for detecting 802.11b preambles quickly and reliable, and allow for reducing the power consumption of an associated WLAN receiver.

This object is achieved by providing an apparatus and a method for detecting 802.11b preambles as described in the independent claims.

Other features which are considered to be characteristic for the invention are set forth in the dependent claims.

The present invention describes a novel apparatus and method for short preamble detection within the framework of the 802.11b standard. The present invention can be easily implemented in both the radio part (preferred embodiment) or the baseband part (general case) of a wireless LAN receiver to provide short preamble detection. The inventive method and apparatus utilize a low-complexity cross-correlator fed by an oversampled signal to detect the presence of a short preamble. A decision on the presence of the short preamble is made by comparing the magnitude of the output sequence of the cross-correlator to a preset threshold. The proposed innovation offers a significant advantage over conventional approaches in terms of gate count and power consumption. Because the apparatus is preferably located within the RF section of the receiver upstream of the baseband section it offloads or discharges the baseband functions by performing a signal discrimination and waking up the baseband functions only if the received signal is determined to embed a 802.11b preamble. Hence, baseband circuitry does not need to be activated every time a “false” signal is received.

For the sake of complexity, it is advisable to move the whole detection process upstream of the baseband part into the radio frequency block of the 802.11b receiver. Hence, the preamble detection shall be carried out within the RF block by cross-correlating a low-resolution quantized oversampled signal with a pre-stored ideal sequence. The idea is to take advantage of the presence of two 1-bit ADCs (clocked at 40 MHz) to obtain a low-resolution quantized signal which feeds the cross-correlator. A decision variable is then issued and compared against a predefined threshold to make a decision.

The inventive solution presents three main advantages over the conventional prior art solutions:
Complexity-wise, the structure of the correlator boils down to its utmost simplicity since the received signal is translated into nothing more than a sequence of zeros and ones, which directly translates into gate savings.
As long as there is no 802.11b preamble detected, the baseband part (including the main ADC) of the receiver can be in “standby mode” since it does not longer need to continually monitor the medium, which directly translate into power savings.
The overall latency of preamble detection is improved by moving the detector into the radio part of the receiver one step closer to the antenna.

### BRIEF DESCRIPTION OF THE DRAWING

FIG. 1 depicts a block diagram of proposed preamble detection apparatus.

### DESCRIPTION OF A PREFERRED EMBODIMENT OF THE INVENTION

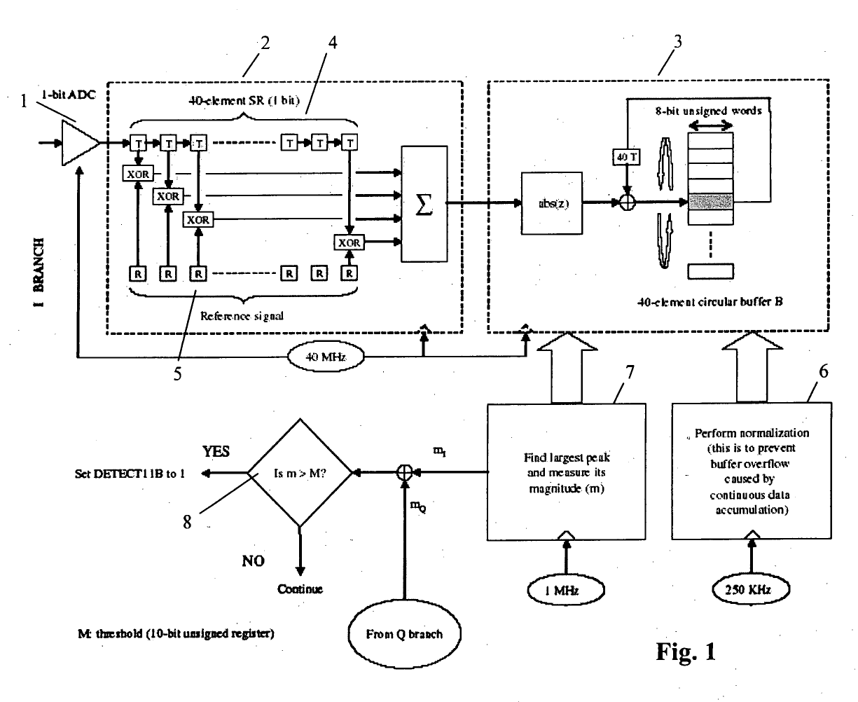

FIG. 1 is a block diagram of proposed preamble detection apparatus. In order to process complex I & Q signals the preamble detector comprises an I-branch and a Q-branch which respectively consist of the in-phase and quadrature components of the received signal. For simplicity, only the I-branch is shown in the drawing. All of the components described in the following are comprised in identical form in the Q-branch.

According to the present invention, in each branch (I or Q) there is provided a low-resolution analog to digital converter 1. The low-resolution ADC 1 preferably consists of a 1-bit ADC which may be a simple comparator. The ADC 1 takes advantage of the particular 802.11b preamble structure (phase modulation) and converts the analog input signal into a digital 1-bit signal stream which is input to the preamble detector.

The 801.11b preamble detector comprises a low-complexity cross-correlator 2 and a circular buffer 3. The signal to be processed in the preamble detector is a sequence of 1-bit samples delivered by the single bit ADC 1.

The cross-correlator 2 comprises a 40-element shift register 4 to which the input signal is permanently clocked in. The content of the shift register 4 is permanently compared with a 40-element reference value 5 which is an ideal local replica of the basic pattern constituting the 802.11b preamble (1-bit quantized oversampled Barker sequence).

The 40-bit samples output by the cross-correlator are converted to absolute values (magnitudes) comprising of 8-bit words. The 8-bit words are input to the 8-bit 40-element circular buffer 3. The buffer 3 is filled up cyclically with the 8-bit input signals. The number of memory elements of the buffer 3 allows accommodating one microsecond worth of signal. It thus takes one microsecond to update the whole content of the buffer 3 which corresponds to the duration of the Barker sequence. The purpose of the buffer is to economically add correlation peaks by taking advantage of the periodic nature of the short preamble. A normalization block 6 is provided for preventing the buffer 3 from overflowing due to continuous data accumulation and/or outstanding cross-correlation peaks.

An evaluation block 7 is provided to evaluate the largest peak value stored in the buffer 3 and determine its magnitude m_{I}.

The same procedure as described above is carried out for the Q-branch of the preamble detector. In this case, the magnitude of the largest detected peak is denoted by m_{Q}.

In a decision block 8 a decision on the presence of the short preamble is made by comparing the figure of merit m formed by adding m_{I} and m_{Q} to a preset threshold value M stored in a preset value register. If the magnitude m exceeds the preset threshold value M, an 802.11b preamble is detected and an output signal is provided which is then used to activate the baseband circuit of the receiver in order to recover the originally transmitted information from the 802.11b signal. If the magnitude m is smaller than the threshold value M, the detection process is continued.

### LIST OF REFERENCE NUMERALS

1 Low-resolution ADC
2 Cross-correlator
3 Buffer
4 Shift register
5 reference value
6 Normalization block
7 Evaluation block
8 Decision block

1. A preamble detector for detecting a 802.11b preamble out from received analog I/Q signals, comprising:
low-resolution analog to digital converters for converting the analog I/Q signals into sequences of digital n-bit I/Q samples,
a low-complexity cross-correlator for correlating the sequences of n-bit I/Q samples with preset reference signals and for generating an output signal if the presence of a 802.11b preamble within the sequences of n-bit I/Q samples is detected.

2. The preamble detector according to claim 1, characterized in that the low-resolution analog to digital converters are 1-bit ADCs.

3. The preamble detector according to claim 1, characterized in that the sequences of n-bit or 1-bit I/Q samples are oversampled signals.

4. The preamble detector according to claim 1, characterized in that a circular buffer is provided where the samples output by the cross-correlator are stored and cyclically overwritten.

5. The preamble detector according to claim 1, characterized in that a normalization block is provided which prevents the buffer from overflowing due to continuous data accumulation and/or outstanding cross-correlation peaks.

6. The preamble detector according to claim 1, characterized in that an evaluation block is provided to evaluate the largest peak value stored in the buffer and determine its magnitude m_{I/Q}.

7. The preamble detector according to claim 1, characterized in that a decision block is provided for making a decision on the presence of the short preamble by comparing a figure of merit m formed by adding m_{I} and m_{Q} to a preset threshold value M stored in a preset value register.

8. The preamble detector according to claim 1, characterized in that it is embedded in the radio frequency part of a wireless radio receiver.

9. The preamble detector according to claim 1, characterized in that it is embedded in the baseband part of a wireless radio receiver.

10. A method for detecting preambles according to 802.11b wireless standard out from received analog I/Q signals, comprising the steps of:
applying a low-resolution analog to digital conversion to the analog I/Q signals for generating sequences of n-bit digital I/Q samples,
detecting 802.11b preambles within the n-bit digital I/Q samples using a low-complexity cross-correlator which correlates the sequences of n-bit I/Q samples with preset reference signals, and
generating an output signal if the presence of a 802.11b preamble within the sequences of n-bit I/Q samples is detected.

11. The method according claim 10, characterized in that the analog I/Q signals are converted into sequences of 1-bit digital I/Q samples.

12. The method according to claim 10, characterized in that the cross-correlator correlates the incoming signal with a 1-bit quantized oversampled Barker sequence which is an ideal local replica of the basic pattern constituting a 802.11b preamble.

13. The method according to claim 10, characterized in that the decision on the presence of the short preamble is made by comparing a figure of merit formed by adding the magnitude of the two largest detected peaks respectively yielded by the both I/Q cross-correlators to a preset threshold.

14. The method according to claim 10, characterized in that the samples output by the cross-correlator fill up and cyclically overwrite a circular buffer.

15. The method according to claim 10, characterized in that the signal to be processed is a sequence of N-bit complex I/Q samples delivered by a pair of N-bit ADCs.

16. The preamble detector according to claim 2, characterized in that the sequences of n-bit or 1-bit I/Q samples are oversampled signals.

17. The preamble detector according to claim 2, characterized in that a circular buffer is provided where the samples output by the cross-correlator are stored and cyclically overwritten.

18. The preamble detector according to claim 3, characterized in that a circular buffer is provided where the samples output by the cross-correlator are stored and cyclically overwritten.

19. The preamble detector according to claim 2, characterized in that a normalization block is provided which prevents the buffer from overflowing due to continuous data accumulation and/or outstanding cross-correlation peaks.

20. The preamble detector according to claim 3, characterized in that a normalization block is provided which prevents the buffer from overflowing due to continuous data accumulation and/or outstanding cross-correlation peaks.
